(19) United States
(12) Patent Application Publication
(10) Pub. No.: US 2007/0067495 A1
(43) Pub. Date: Mar. 22, 2007

(54) Web server

(75) Inventor: Richard Derek Levy, Thames Ditton (GB)

Correspondence Address: FOGG AND ASSOCIATES, LLC, P.O. BOX 581339, MINNEAPOLIS, MN, 55458-1339, US

(73) Assignee: Nucleus Limited, Thames Ditton (GB)

(21) Appl. No.: 11/334,311

(22) Filed: Jan. 18, 2006

(30) Foreign Application Priority Data
Jun. 29, 2005 (GB) 0513333.5

(51) Int. Cl. G06F 15/16

(52) U.S. Cl. 709/246

(57) ABSTRACT

An intermediary web server 2 and a plurality of content web servers 4 each store web site data. Each of a plurality of client apparatus 6 is operable to download web pages from intermediary server 2 and from each content server 4 by communicating with intermediary server 2 and without having to communicate directly with a content server 4. Intermediary server 2 reads communications between each client apparatus 6 and each content server 4. Intermediary server 2 modifies web page data transmitted from a content server 4 to a client 6 firstly by modifying all links defining data to be displayed within the page so that each link has a unique address, and secondly by adding content to be displayed at the client. Intermediary server 2 also identifies requests of a predetermined type sent from a client 6 to a content server 4 and stores a copy of the request.

### CROSS-REFERENCE TO RELATED APPLICATION

This application claims the right of priority under 35. U.S.C. § 119 based on British Patent Application No. 0513333.5, filed 29 Jun. 2005, which is hereby incorporated herein in its entirety as if fully set forth herein.

### TECHNICAL FIELD

The present invention relates to the field of web servers.

### BACKGROUND

Access to web sites via the internet is well known. A client apparatus (such as a personal computer) running browser software communicates with a server storing web site data and running web server software to access the web site data and display it at the client apparatus.

Typically, each page of the web site is defined using a markup language, such as a HTML (hypertext markup language). The markup language is transmitted from the web server via the internet to the client. The browser of the client then parses the markup language, identifies from the markup language any further content that is to be displayed within the web page (such as images, logos, etc.) and sends instructions back to the web server to request that content. In response, the web server returns the requested content, which is then combined at the client browser with the content previously received, and displayed in a format defined by the markup language.

One problem which has arisen is that it is desirable for the provider of a first web site to provide access to different web sites at different web servers.

This problem has previously been addressed by providing in the web page of the first server selectable links to the web sites at each of the second servers. In response to the selection of a link by a client apparatus, a separate and independent connection is established between the client and the second web server defined by the link. Web pages received by the client from the second web server are then displayed using one of two methods. In a first method, the web site of the second server is displayed in a second window at the client while the web site of the first server is displayed in a first window (or the connection between the client and the first server is broken with the result that the first web site is not displayed at all). Alternatively, in a second method, the markup language of the web page from the first web server defines a window occupying a portion of the displayed page from the first web server and the web page from the second web server is displayed within this window. As a result, in the second method, the web page from the first web server and the web page from the second web server are displayed simultaneously within one overall page. In both cases, however, the connection between the client and the first web server is separate and independent from the connection between the client and the second web server. As a result, a number of problems arise. For example, the first web server can not control the content of web pages from a second web server. In addition, the first web server cannot monitor any of the communications between the client and a second web server.

The present invention aims to address one or more of these problems.

### SUMMARY

According to the present invention, there is provided a system comprising a plurality of web servers each storing web site data and a plurality of client apparatus each having a browser for retrieving and displaying the web site data. The web servers and client apparatus are operatively connected to an intermediary server, through which the client apparatus and the web servers communicate. Each web server transmits web page data, in which data to be displayed within the web page is defined through the use of a link defining a location from which the data is to be retrieved. The intermediary server includes a web-data processor arranged to modify each link defined in a web page transmitted from a web server to a client apparatus such that the link defines a unique location address.

The features of the web-data processor ensure that the correct data to be displayed within a web page can be retrieved when it is requested by a client apparatus. Without the web-data processor, web page data from one web server may define a location at that web server (such as a stored data file) using a name which is the same as the name used by a different web server or the intermediary server to define a location at that different web server or a location at the intermediary server. In this case, when a client apparatus requests data from the location of that name, the location from which the data is to be retrieved is ambiguous. As a result, the wrong data may be returned to the client apparatus leading to a display of incorrect web page data. The web-data processor of the intermediary server avoids this problem by changing the name of each data location to a unique name.

The present invention also provides an intermediary web server for use in the system above.

The present invention further provides computer program products for implementing the features above.

### BRIEF DESCRIPTION OF THE DRAWINGS

Embodiments of the present invention will now be described, by way of example only, with reference to the accompanying drawings, in which like reference numbers are used to designate like parts, and in which:

FIG. 1 schematically shows the components of a system in a first embodiment, together with the notional functional processing units into which the computer components may be thought of as being configured when programmed by programming instructions;

FIG. 2, comprising FIGS. 2a to 2c, shows the processing operations performed by the apparatus in the system of FIG. 1;

FIG. 3 shows the processing operations performed by the intermediary server in the system of FIG. 1 at step S2-26 in FIG. 2;

FIG. 4 shows the processing operations performed by the intermediary server in the system of FIG. 1 at step S2-38 in FIG. 2; and

FIG. 5, comprising FIGS. 5a to 5d, shows the processing operations performed by the apparatus in the system of FIG. 1 when secure communication is required.

### DETAILED DESCRIPTION

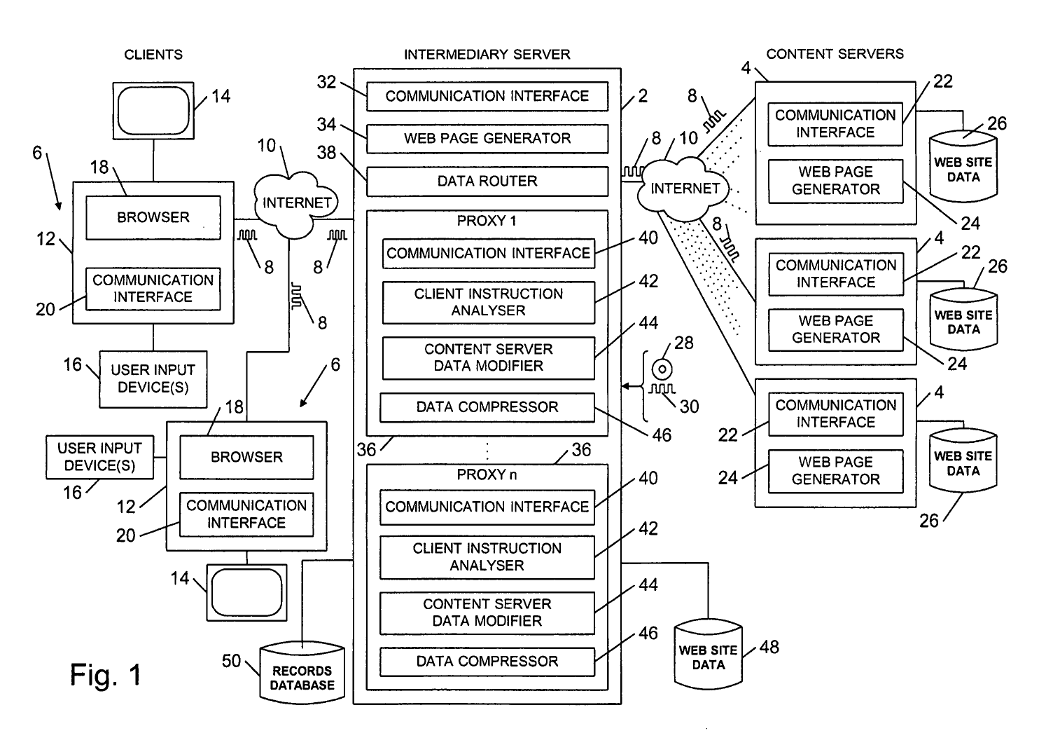

Referring to FIG. 1, an intermediary web server 2 and a plurality of content web servers 4 each store web site data defining a plurality of web pages. Each of a plurality of client apparatus 6 is operable to download web pages from the intermediary server 2 and from each of the content servers 4 by communicating with the intermediary server 2 and without having to communicate directly with a content server 4. In use, each client apparatus 6 is operatively connected to exchange data with the intermediary server 2 by transmitting signals 8 via the internet 10. Similarly, the intermediary server 2 and each content server 4 are operatively connected to exchange data by transmitting signals 8 via the internet 10.

As will be explained in more detail below, intermediary server 2 is arranged to read all communications in both directions between each client apparatus 6 and each content server 4. Intermediary server 2 is arranged to modify web page data transmitted from a content server 4 to a client 6 in two different ways—firstly, to modify all links defining data to be displayed within the page so that each link has a unique address (thereby ensuring that the correct content can be identified and returned to the client when the client requests it for display), and secondly to add content to be displayed at the client (in this embodiment to add image data to. present the web page as a web page belonging to the intermediary server, although other forms of content could be added as described later). In addition, intermediary server 2 is arranged to identify requests of a predetermined type sent from a client 6 to a content server 4 and to store a copy of the request.

Each of the client apparatus 6, intermediary server 2 and content servers 4 comprises a programmable processing apparatus programmed to operate in accordance with computer programming instructions. When programmed by the programming instructions, each apparatus 2, 4, 6 can be thought of as being configured as a number of functional units for performing processing operations. Examples of such functional units are shown in FIG. 1. The units illustrated in FIG. 1 are, however, notional and are shown for illustration purposes only to assist understanding; they do not necessarily represent units and connections into which the processors, memories, etc. of the apparatus 2, 4, 6 actually become configured.

Each client apparatus 6 comprises a conventional personal cumputer 12 connected to a display 14 and one or more user input devices such as a keyboard, mouse, etc. The computer program instructions configure the personal computer 12 to include a number of functional units, including a browser 18 and a communication interface 20. Further details of these functional units will not be provided as they are conventional in the art.

Each content server 4 comprises a conventional hardware server running web server software which defines functional units such as a communication interface 22 and a web page generator 24. Again, further details of these functional units will not be provided as they are conventional in the art. Each content server 4 is connected to a database 26 storing web site data defining the web pages available from the content server.

In this embodiment, intermediary server 2 comprises dual CPU 2.8 GHz Pentium 4 Enterprise Linux servers with 2 Gb RAM and 150 Gb disc space, together with a load balancer to distribute the processing load between the servers. The intermediary server 2 is connected to the internet 10 via a 200 Mbit backbone and firewall (not shown). Other hardware configurations are, of course, possible for the intermediary server 2.

The intermediary server 2 is programmed in accordance with programming instructions input, for example, as data stored on a data storage medium 28 (such as an optical CD ROM, semiconductor ROM, magnetic recording medium, etc.), and/or as a signal 30 (for example an electrical or optical signal input to the intermediary server 2, for example from a remote database, by transmission over a communication network such as the internet or by transmission through the atmosphere), and/or entered by a user via a user input device such as a keyboard.

The computer program instructions define functional processing units comprising a communication interface 32, a web page generator 34, a plurality of proxies 36 and a data router 38.

Communication interface 32 and web page generator 34 are conventional in the art, and will not be described further here.

Each proxy 36 comprises a modified Apache web server and is configured to talk to a different respective one of the content servers 4 (that is, each proxy 36 is configured to send data to, and receive data from, only one domain name, defining the address of a unique content server 4).

Each proxy 36 contains functional units comprising a communication interface 40, a client instruction analyser 42, a content server data modifier 44 and a data compressor 46.

Communication interface 40 is arranged to handle communications between a client apparatus 6 and the intermediary server 2 and communications between the intermediary server 2 and a respective one of the content servers 4.

Client instruction analyser 42 is arranged to read and test all data received from a client apparatus 6 to determine whether it contains data of a predetermined type, and to write a copy of any such identified data to storage.

Content server data modifier 44 is arranged to read all data sent from a content server 4 to a client 6 and to modify the data in two different ways—firstly by changing any link in the data defining content that is to be subsequently retrieved by the client 6 from a content server 4 so that the link defines a unique address for the content to be retrieved, and secondly to include data to be displayed at the client 6 as part of the web page from the content server 4 to present the web page as a web page of the intermediary server 2.

Data compressor 46 is arranged to compress data for transmission to a client apparatus 6.

Data router 38 is arranged to process initial requests from a client apparatus 6 and to route the requests to the proxy 36 which is configured to communicate with the content server 4 with which the requesting client apparatus 6 wishes to communicate.

Intermediary server 2 is connected to a database 48 storing web site data defining web pages of the intermediary server 2 and content to be added to web pages of a content server 4 by a content server data modifier 44. In addition, intermediary server 2 is connected to a records database 50 for storing copies of data identified by client instruction analyser 42.

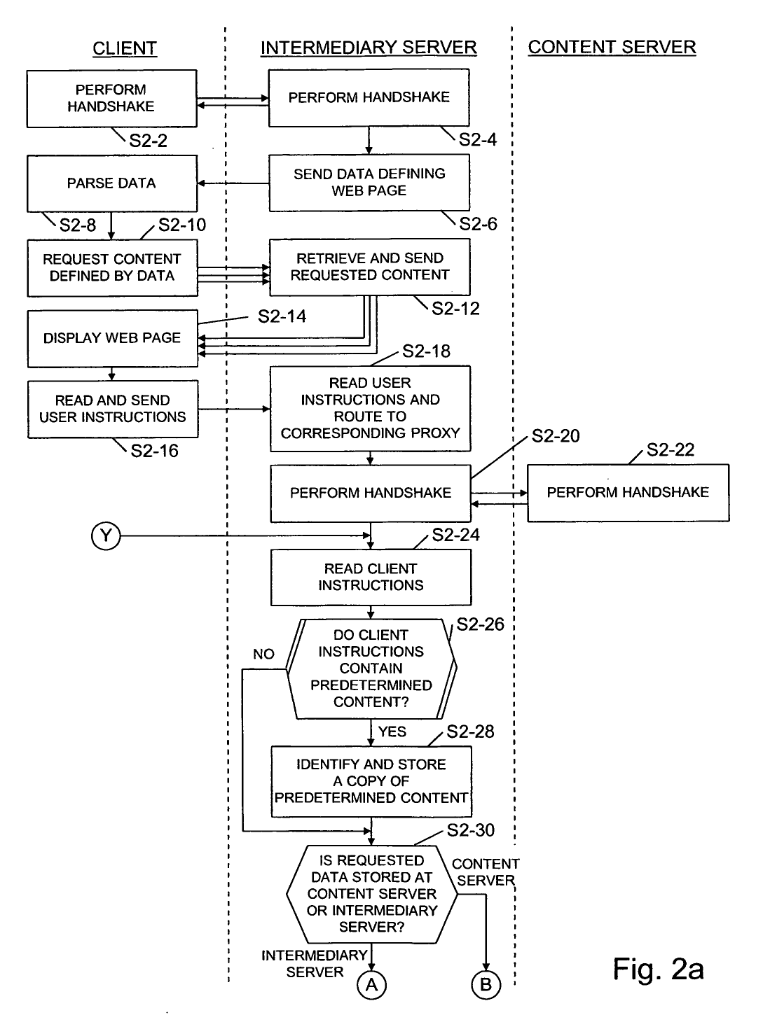

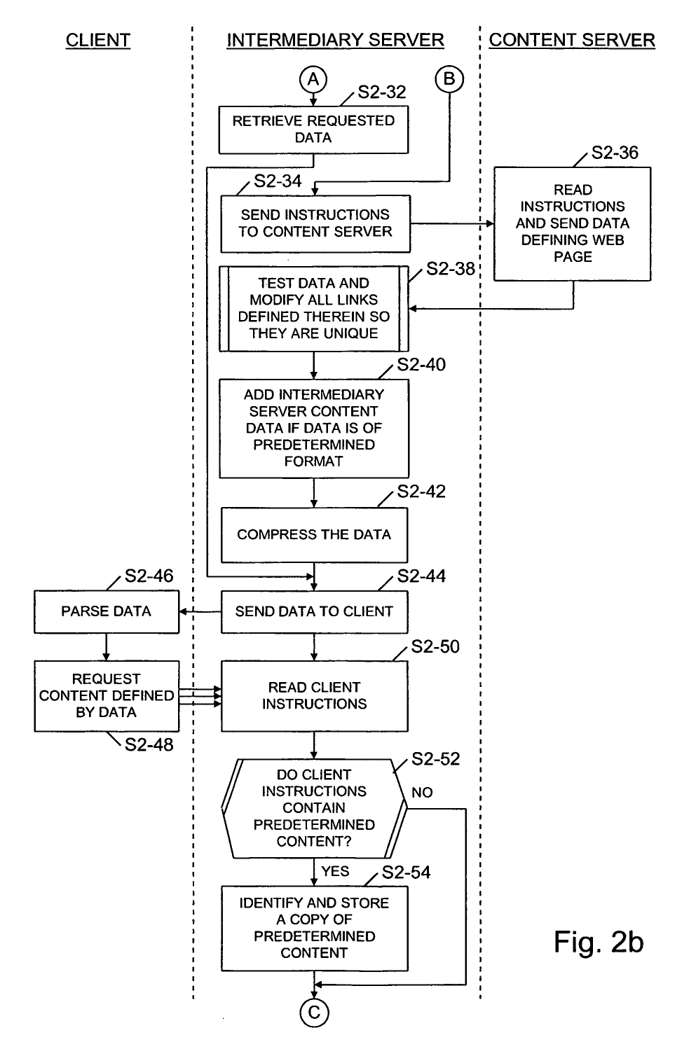

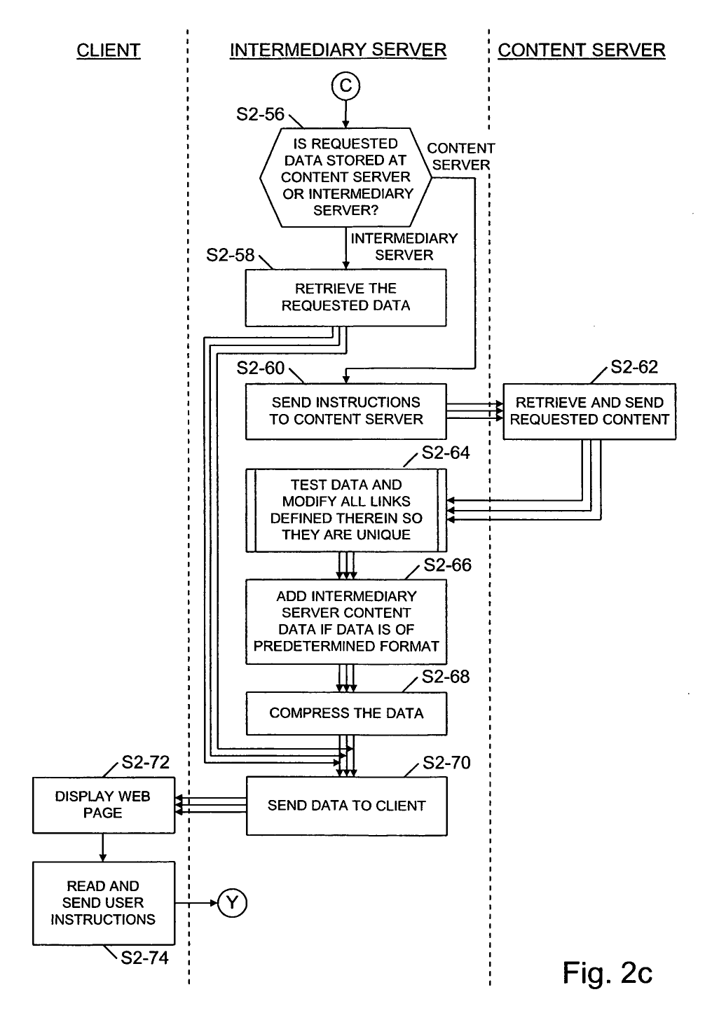

FIG. 2 shows the processing operations performed by a client apparatus 6, intermediary server 2 and a content server 4. In this Figure, the processing operations performed by each apparatus are delimited by dotted lines, with the processing operations performed by the client apparatus 6 being set out in the left column, the processing operations performed by the intermediary server 2 being set out in the centre column, and the processing operations performed by the content server 4 being set out in the right column.

Referring to FIG. 2, the processing operations performed at steps S2-2 to S2-14 comprise operations performed by the client apparatus 6 and the intermediary server 2 when the client apparatus 6 initially connects to the intermediary server 2 and requests a web page (typically the home page) stored at the intermediary server 2.

More particularly, at steps S2-2 and S2-4, communication interface 20 within client apparatus 6 and communication interface 32 within intermediary server 2 perform conventional handshake operations to establish a connection, such as an http connection, over the internet 10.

At step S2-6, web page generator 34 retrieves data defining the home page of the intermediary server 2 from the database 48, and communication interface 32 transmits the data to client apparatus 6. In this embodiment, the web page data comprises HTML data, although other forms of data could, of course, be used instead.

At step S2-8, browser 18 parses the HTML data received from intermediary server 2, and at step S2-10 issues requests to the intermediary server 2 for content defined in the HTML data that is to be displayed as part of the defined web page. The content may comprise, in a conventional way, one or more images, logos, style sheets, further text, audio, etc., and the requests for the data are issued as conventional “GET/” commands.

At step S2-12, web page generator 34 retrieves the requested content from database 48 and communication interface 32 transmits the retrieved content to client 6.

At step S2-14, browser 18 processes the HTML data received at step S2-8 and the content data received from intermediary server 2 and displays the web page on display 14 in accordance with the format defined by the HTML.

The processing operations performed at steps S2-16 to S2-74 comprise operations performed when the user at client apparatus 6 selects a link in the displayed web page in order to connect to the web site of a content server 4.

More particularly, at step S2-16, browser 18 reads data defining the link selected by the user, and communication interface 20 sends data requesting connection to the domain address defined in the link to the intermediary server 2.

At step S2-18, data router 38 reads the instructions received from the client 6 and routes the request to the proxy 36 which is configured to communicate with the content server 4 at the domain address defined in the request.

Subsequent processing operations performed by intermediary server 2 and described below are performed by the proxy 36 to which the instructions are routed by the data router 38 at step S2-18.

At steps S2-20 and S2-22, communication interface 40 within proxy 36 and communication interface 22 within content server 4 perform conventional handshake operations to establish a connection, such as an http connection, over the internet 10.

At step S2-24, client instruction analyser 42 reads the instructions received from client apparatus 6, and at step S2-26 determines whether the client instructions contain predetermined content.

The purpose of the processing at step S2-26 is to identify a request made by a client apparatus 6 to a content server 4 which necessitates action by the intermediary server 2. Applications of this processing are many and varied, as will be described later.

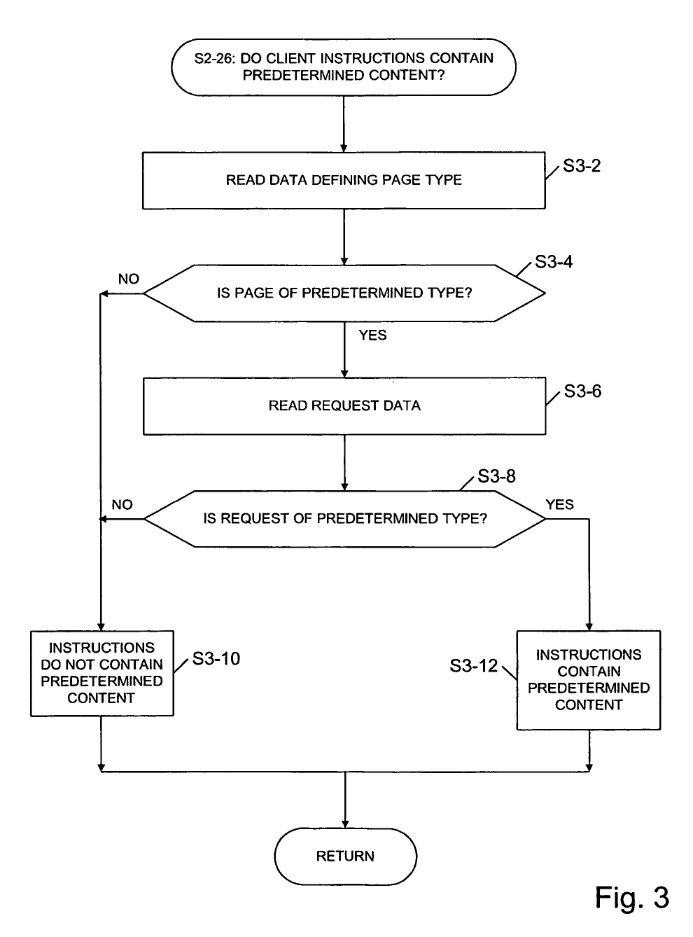

FIG. 3 shows the processing operations performed by client instruction analyser 42 at step S2-26 in this embodiment, although many different processing operations may be performed depending upon the nature of the predetermined data that is to be detected.

Referring to FIG. 3, at step S3-2, client instruction analyser 42 reads data defining the page type requested by client apparatus 6. In this embodiment, this is performed by reading the page type defined by the $r-uri data in the request.

At step S3-4, client instruction analyser 42 determines whether the page type read at step S3-2 defines a predetermined type of page to be detected (for example by comparing the type read at step S3-2 with stored data defining one or more predetermined types of page to be detected).

If it is determined at step S3-4 that the page is not of a type requiring action, then the processing proceeds to step S3-10 at which a negative result is returned for the processing.

On the other hand, if it is determined at step S3-4 that the requested page is of a predetermined type, then processing proceeds to step S3-6, at which client instruction analyser 42 reads the request data to determine the type of request.

At step S3-8, client instruction analyser 42 determines whether the request is of a predetermined type, such as “post” request (for example by comparing the client request with stored data defining one or more predetermined request types to be detected).

If it is determined at step S3-8 that the request is not of a predetermined type, then processing proceeds to step S3-10, at which a negative result for the processing is returned. Alternatively, if it is determined at step S3-8 that the request is of a predetermined type, then processing proceeds to step S3-12, at which a positive result is returned for the processing.

Referring again to FIG. 2, if a positive result is returned by the processing at step S2-26 (that is, client instructions containing predetermined content have been identified), then processing proceeds to step S2-28, at which intermediary server 2 performs an action in dependence upon the predetermined content. In this embodiment, at step S2-28, client instruction analyser 42 stores a copy of the predetermined content identified at step S2-26 in records database 50. This copy may comprise all of the instructions from the client or only a subset of the data defined in the instructions, depending upon the application.

Step S2-28 is omitted if it is determined at step S2-26 that the client instructions do not contain predetermined content.

At step S2-30, client instruction analyser 42 determines whether the web page data required to be sent in response to the client instructions is stored at the intermediary server 2 or the content server 4.

If it is determined at step S2-30 that required data is stored at the intermediary server 2, then processing proceeds to step S2-32, at which client instruction analyser 42 retrieves the requested data from database 48, and then step S2-44 at which communication interface 40 transmits the retrieved data to client apparatus 6.

On the other hand, if it is determined at step S2-30 that required data is stored at content server 4, then processing proceeds to step S2-34, at which communication interface 40 sends instructions requesting the data to content server 4. (It should be noted that the processing at step S2-30 may determine that some web page data required by the client is stored at the intermediary server 2 and that some web page data required by the client is stored at content server 4. In this case processing proceeds to both step S2-32 and step S2-34.)

At step S2-36, the instructions from intermediary server 2 are read by content server 4 and the requested data is retrieved from database 26 and transmitted back to intermediary server 2.

In this embodiment, web pages stored at each content server 4 are defined by HTML, and accordingly it is the HTML data which is sent to intermediary server 2 at step S2-36. This HTML data defines, in a conventional way, one or more links, each defining the location of content (such as one or more images, logos, style sheets, further text, audio, etc.) which is required for display within the defined web page and which needs to be subsequently requested by client 6, retrieved from database 26 of content server 4 and returned to client 6 via intermediary server 2.

At step S2-38, content server data modifier 44 tests the data received from content server 4 and modifies all links defining content to be subsequently retrieved from content server 4, so that each link defines a unique location address.

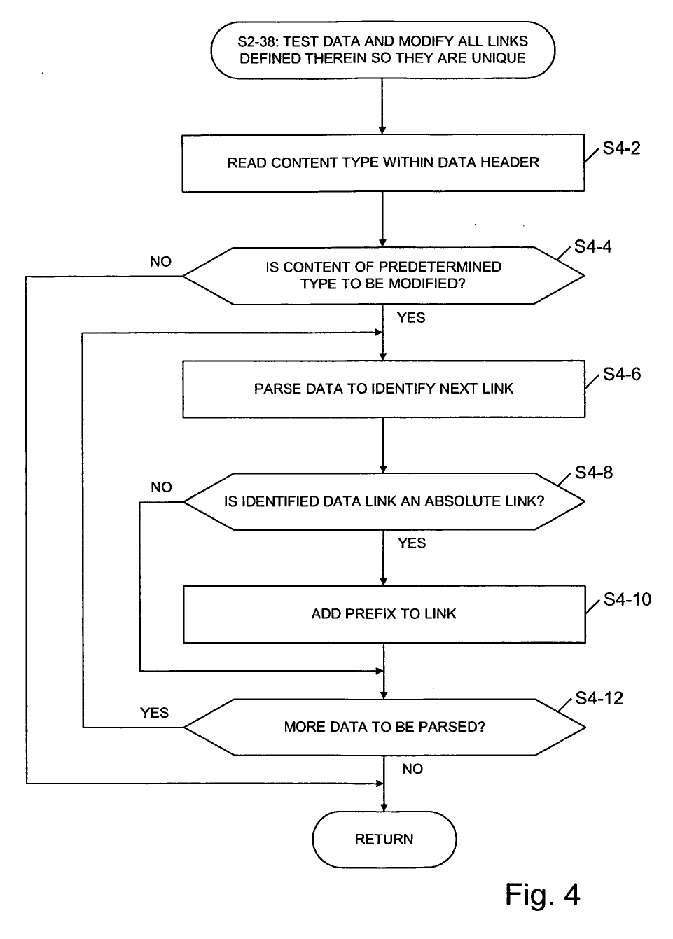

FIG. 4 shows the processing operations performed by content server data modifier 44 at step S2-38 in this embodiment.

Referring to FIG. 4, at step S4-2, content server data modifier 44 reads data within the header defining the content type of the data. In this embodiment, this process is performed by reading the $r-uri and the $r-content type data within the header.

At step S4-4, content server data modifier 44 determines if the type of data is a predetermined type to be modified. More particularly, in this embodiment, content server data modifier 44 determines whether the data is of a type “text/HTML”, where the portion before the “/” defines the “main” type of the data and the portion after the “/” defines the “minor” type of the data.

If it is determined at step S4-S4 that the data is not of a predetermined type to be modified, then the processing at step S2-38 ends and the processing proceeds to step S2-40 in FIG. 2. As a result, only data of type “text/HTML” undergoes further processing for modification at step S2-38 and data of other types, such as plain text, rich text, image data etc. is not modified.

When it is determined at step S4-S4 that the data from content server 4 is of a predetermined type to be modified, then processing proceeds to step S4-S6, at which content server data modifier 44 parses the data to identify the next link therein defining content data to be retrieved from content server 4 for display as part of the web page (this being the first such link the first time step S4-S6 is performed) . In this embodiment, content server data modifier 44 identifies a link by parsing the data to identify data defining a predetermined tag having a predetermined attribute. More particularly, content server data modifier 44 identifies the following links and attributes, in which the text on the left of the “ [symbol] ” symbol identifies the tag for which content server data modifier 44 searches and the text on the right of the “ [symbol] ” symbol identifies the attribute or attributes associated the tag for which content server data modifier 44 searches (any one of which may be present for content server data modifier 44 to identify a link):

| | |
|---|---|
| ‘a’ | => [‘href’], |
| ‘applet’ | => [‘archive’, ‘codebase’, ‘code’], |
| ‘area’ | => [‘href’], |
| ‘base’ | => [‘href’], |
| ‘bgsound’ | => [‘src’], |
| ‘blockquote’ | => [‘cite’], |
| ‘body’ | => [‘background’], |
| ‘del’ | => [‘cite’], |
| ‘embed’ | => [‘pluginspage’, ‘src’], |
| ‘form’ | => [‘action’], |
| ‘frame’ | => [‘src’, ‘longdesc’], |
| ‘iframe’ | => [‘src’, ‘longdesc’], |
| ‘ilayer’ | => [‘background’], |
| ‘img’ | => [‘src’, ‘lowsrc’, ‘longdesc’, ‘usemap’], |
| ‘input’ | => [‘src’, ‘usemap’], |
| ‘ins’ | => [‘cite’], |
| ‘isindex’ | => [‘action’], |
| ‘head’ | => [‘profile’], |
| ‘layer’ | => [‘background’, ‘src’], |
| ‘link’ | => [‘href’], |
| ‘object’ | => [‘classid’, ‘codebase’, ‘data’, ‘archive’, ‘usemap’], |
| ‘q’ | => [‘cite’], |
| ‘script’ | => [‘src’, ‘for’], |
| ‘table’ | => [‘background’], |
| ‘td’ | => [‘background’], |
| ‘th’ | => [‘background’], |
| ‘tr’ | => [‘background’], |
| ‘xmp’ | => [‘href’]. |

At step S4-S8, content server data modifier 44 determines whether the link identified at step S4-S6 is an absolute link. In this embodiment, content server data modifier 44 reads the data defining the source of the link and determines that the link is an absolute link if it starts “http:”, “https:” or “/”.

If it is determined at step S4-8 that the identified link is an absolute link, then processing proceeds to step S4-10, at which content server data modifier 44 adds a prefix to the link to ensure that it defines a unique location. By way of example, if the link is of a form “/logo.gif”, then in this embodiment, content server data modifier 44 adds a prefix to the link so that it reads “/subject matter/content server name/logo.gif”, where the subject matter defines the subject with which the content server is associated (such as hotels, airlines, scientific periodicals, etc.) and the content server name defines the domain name of the content server 4 from which the data was received.

As a result of the processing at step S4-10, a link defining a location which is unique only within the confines of content server 4 is amended so that it defines a location which is unique in absolute terms. Consequently, when a request for the data stored at the address of the link is returned by client 6, the request can be processed by intermediary server 2 and directed to the appropriate server at which the data is stored. For example, as will be described in more detail later, if the link includes the prefix “/subject matter/content server name”, then intermediary server 2 determines that the requested data is not stored within the intermediary server itself, reads the name of the defined content server and communicates the request to that content server 4.

Referring to the previous example of the link “/logo.gif”, the link defines data stored in a file entitled “logo” in the web site data stored at the content server 4, and was generated independently of, and without knowledge of, the web site data stored at all of the other content servers 4 and also from the web site data stored at intermediary server 2. Consequently, one or more of the other content servers 4 or the intermediary server 2 itself may store web site data in a file entitled “logo”. Accordingly, if the link “/logo.gif” was not amended to make it unique, then a request from a client 6 for data stored at the location “/logo.gif” may result in the wrong data being returned to the client and therefore the wrong web page content being displayed at client 6. Performing the processing at step S4-10 therefore ensures that the correct data can be identified, retrieved and transmitted to the client 6 by intermediary server 2.

It will therefore be understood that the processing performed by content server data modifier 44 within intermediary server 2 prevents the need for the web site data stored at each content server 4 and intermediary server 2 to be written in a coordinated manner so that no two links to web site data stored at any server are the same.

In addition, by providing content server data modifier 44 as part of intermediary server 2, it is not necessary to modify the web server on any content server 4 or to allocate additional processing resources to any content server 4.

Referring back to the processing at step S4-S8, if it is determined that the link identified at step S4-S6 is not an absolute link, then the processing at step S4-10 described above is omitted. As a result, a relative link (for example defining a location relative to the web pages itself) is not modified.

At step S4-12, content server data modifier 44 determines whether there is any further data to be parsed, and the processing at steps S4-S6 to S4-12 is repeated until all of the data has been processed in the way described above.

Referring again to FIG. 2, at step S2-40, content server data modifier 44 tests the data sent from content server 4 at step S2-36 to determine whether the data defines a web page and, if it does, modifies the data to define a link to data stored in database 48 which is to be included within the displayed web page. The purpose of this processing is to modify a web page from content server 4 so that it is presented as a web page from intermediary server 2 when it is displayed at the client apparatus 6.

In this embodiment, content server data modifier 44 determines whether the data received from content server 4 comprises HTML data and, if it does, adds additional HTML data before the closing tag defining a link to an image of the intermediary server's logo stored in database 48. As a result, when the HTML data defining the web page is parsed by client apparatus 6, the client apparatus returns a request for the logo image data stored in database 48, and intermediary server 2 retrieves the logo image data and transmits it to the client 6 for display as part of the web page from content server 4.

The processing at step S2-40 therefore results in web page data from the content server 4 being combined with data from the intermediary server 2 at the intermediary server (and not in the browser 18 of the client apparatus 6 as described in the introduction of the present application in the case where the web page from a first web server defines a window in which data from a second web server is displayed as a result of a separate and independent connection thereto).

At step S2-42, data compressor 46 compresses the data received from content server 4 and processed at steps S2-38 and S2-40. In this embodiment, data compressor 46 performs a “gzip” or a “deflate” compression operation, although other types of data compression operations may be performed instead. Data that is already in compressed format, for example JPEG data, is not compressed in this embodiment at step S2-42, however.

By performing the compression processing at step S2-42, intermediary server 2 reduces the transmission time required to transmit the data to client apparatus 6, thereby compensating for the time required to perform the processing at steps S2-38 and S2-40. As a result, the data received from content server 4 is processed by intermediary server 2 and transmitted to client apparatus 6 in real time, that is in a time sufficiently short that the user at client apparatus 6 does not experience any difference in time delay between receiving data when accessing the content server 4 via the intermediary server 2 and receiving data when accessing the content server 4 directly.

At step S2-44, communication interface 40 transmits the data to client apparatus 6.

At step S2-46, browser 18 within client apparatus 6 parses the data in the same way as at step S2-8 described previously.

At step S2-48, client apparatus 6 sends requests to the intermediary server 2 for content data defined in the data parsed at step S2-46 to be necessary for the display of the web page.

As described previously with reference to the processing at step S2-10, each request generated by client apparatus 6 has the form “get/”. Accordingly, with reference to the example of the modified link “/subject matter/content server name/logos.gif” described above with reference to the processing at step S2-38, client apparatus 6 generates and transmits a request “get/subject matter/content server name/logo.gif”. Similarly, client apparatus 6 generates and transmits a GET request for the content defined by the link added by intermediary server 2 at step S2-40 above.

At step S2-50, communication interface 40 within the proxy 36 with which the client apparatus 6 is communicating reads the client instructions.

At step S2-52, client instruction analyser 42 processes the client instructions to determine whether they contain predetermined content, and at step S2-54 stores a copy of any identified predetermined content. The processing performed at steps S2-52 and S2-54 is the same as the processing at steps S2-26 and S2-28 described above, and accordingly will not be described again here.

At step S2-56, client instruction analyser 42 determines whether data requested by client apparatus 6 is stored at the intermediary server 2 itself and/or at a content server 4.

For any data determined to be stored at the intermediary server 2 (such as the data stored at the location defined by the link added by content server data modifier 44 at step S2-40), client instruction analyser 42 retrieves the requested data from database 48 at step S2-58, and processing proceeds to step S2-70 at which communication interface 40 transmits the data to the requesting client apparatus 6.

On the other hand, for any data determined at step S2-56 to be stored at a content server 4, processing proceeds to step S2-60, at which client instruction analyser 42 generates instructions which are transmitted by communication interface 40 to the content server 4. More particularly, client instruction analyser 42 generates each instruction by removing the prefix previously added as part of the processing at step S2-38 and transmits the modified instruction without the prefix. As a result, the location defined in the instruction transmitted by intermediary server 2 is of the original format transmitted in the data from content server 4 at step S2-36, thereby enabling content server 4 to properly locate the required data. By way of example, referring to the example command “get/subject matter/content server name/logo.gif” described above, this instruction would be modified by client instruction analyser 42 at step S2-56 to read “get/logo.gif” before transmission to content server 4.

At step S2-62, content server 4 retrieves requested data from database 26 and returns it to intermediary server 2.

At steps S2-64 to S2-70, intermediary server 2 performs processing corresponding to the processing performed at steps S2-38 to S2-44. As this processing has already been described above, it will not be described again here.

At step S2-72, browser 18 within client apparatus 6 displays the requested web page. As described previously, the displayed web page will comprise the web page defined by the data stored at content server 4 modified to include the logo of intermediary server 2, thereby presenting the web page as a web page of the intermediary server 2.

At step S2-74, browser 18 reads user instructions for the display of a further web page, and the processing returns to step S2-24.

The selection of a new web page at step S2-74 may require data to be transmitted securely between the client apparatus 6, intermediary server 2 and a content server 4. Browser 18 within client 6 determines whether a selected web page requires secure communication in dependence upon the link to the web page defined in the currently displayed web page. For example, if the link defines a “HTTP/S” connection (that is, HTTP-SECURE), then browser 18 determines that a secure connection is required.

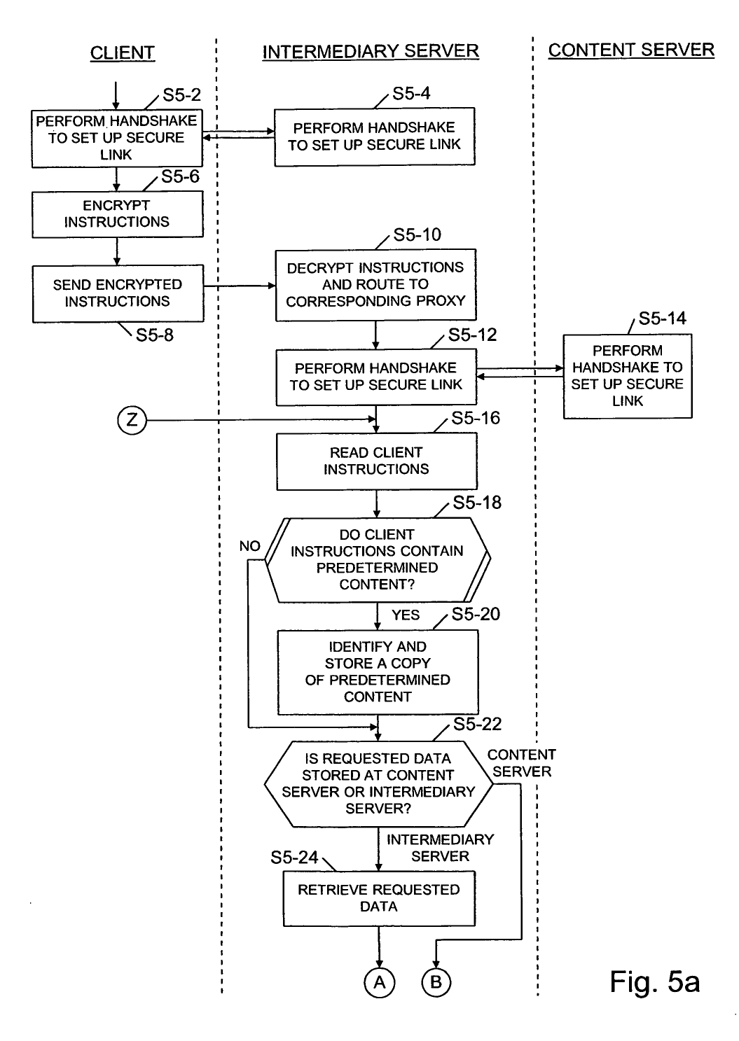

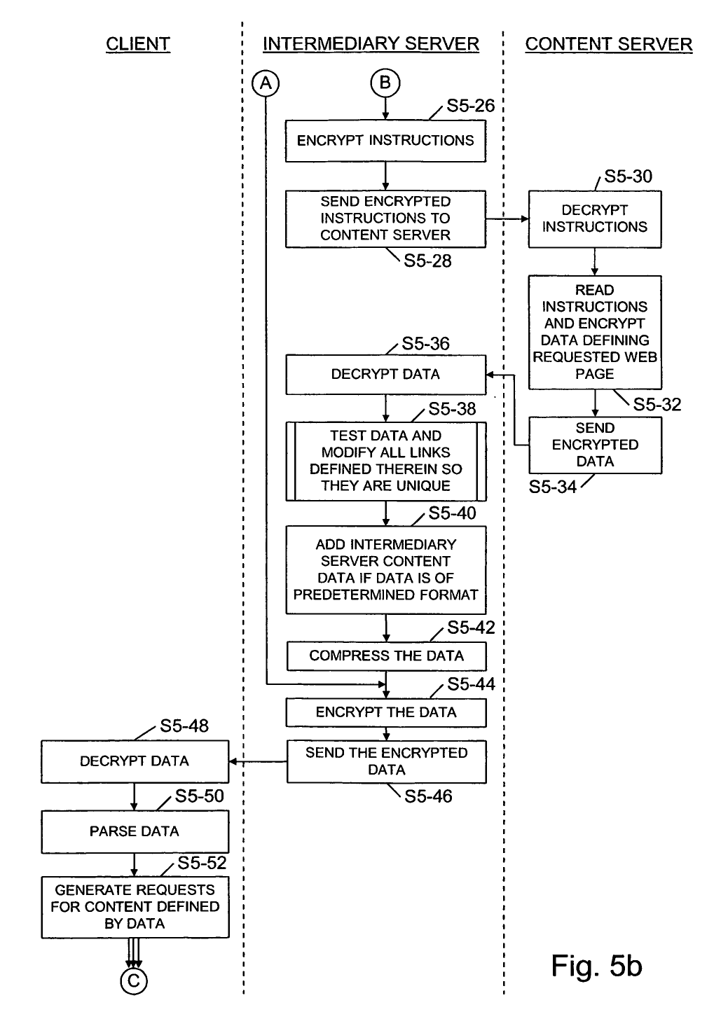

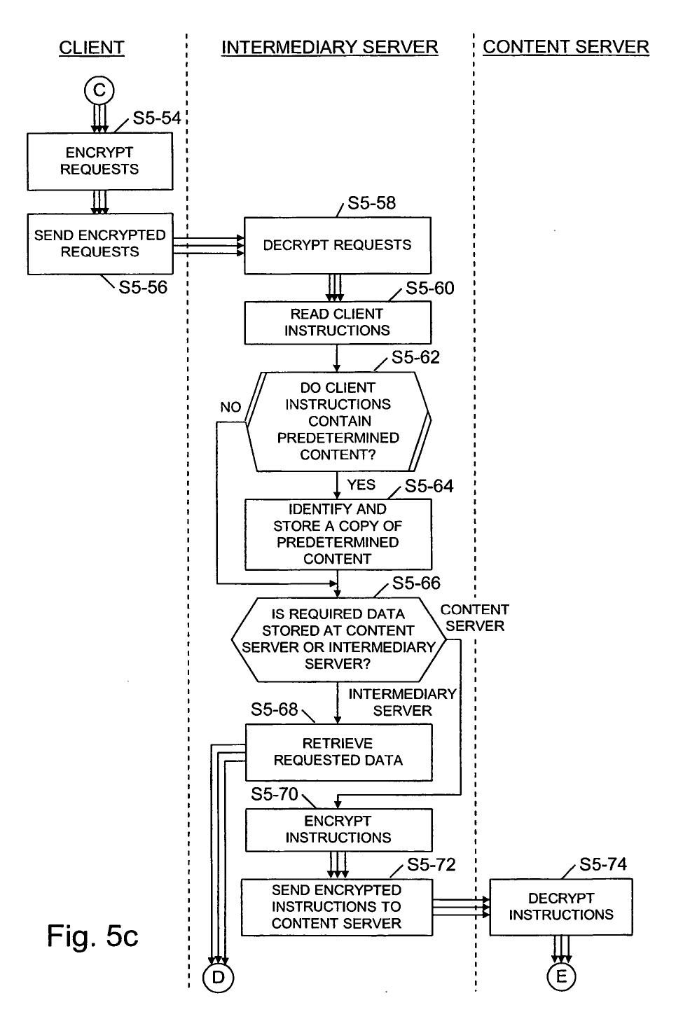

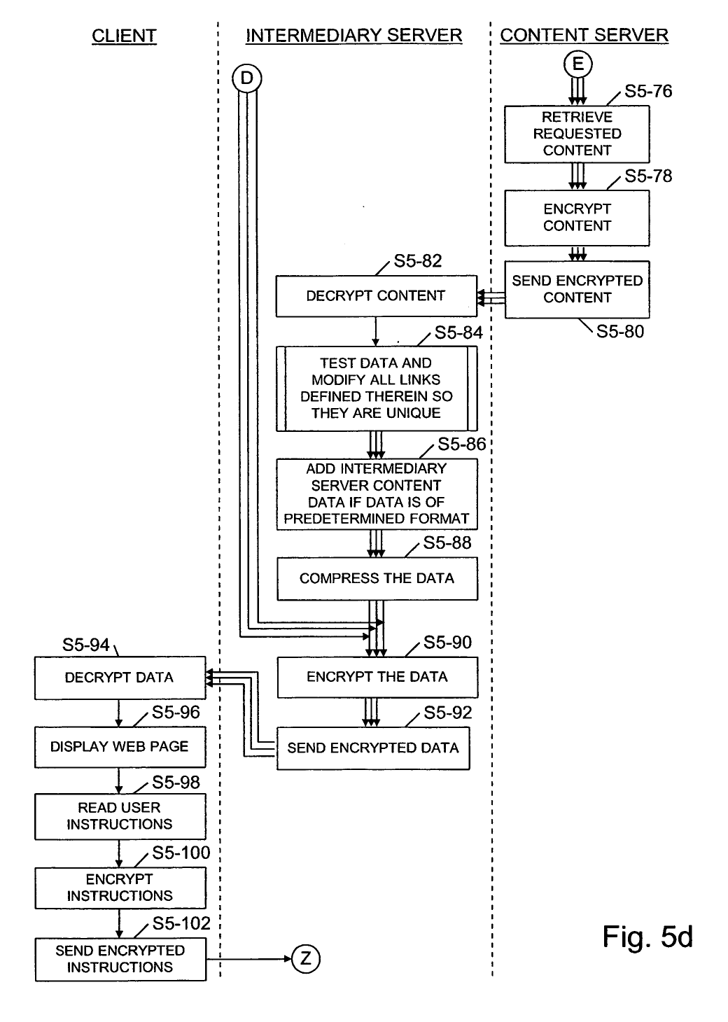

FIG. 5 shows the processing operations performed when browser 18 in client apparatus 6 determines that a requested web page requires secure communication. It should be noted that the selected web page requiring secure communication may be a web page stored on that the same content server 4 from which client apparatus 6 has already received the currently displayed web page or may be a web page stored on a different content server. In either event, the processing operations performed are the same.

Referring to FIG. 5, at steps S5-2 and S5-4, client apparatus 6 and intermediary server 2 perform conventional handshake operations to set up a secure communication link, such as a link secured in accordance with the Secure Sockets Layer (SSL) protocol.

At steps S5-6 and S5-8, instructions defining a request for the required web page are encrypted by client apparatus 6 and transmitted to intermediary server 2.

At step S5-10 the instructions are decrypted by intermediary server 2 and routed to the proxy 36 corresponding to the content server 4 at which the requested web page is stored.

At steps S5-12 and S5-14, the proxy 36 and content server 4 perform handshake operations to set up a secure communication link, such as an SSL link.

At steps S5-16 to S5-102, processing operations are performed by intermediary server 2, content server 4 and client apparatus 6 corresponding to the processing operations performed at steps S2-24 to S2-74 described above, with the exception that data is encrypted before transmission and decrypted upon receipt in accordance with the processing operations performed at steps S5-26, S5-30, S5-32, S5-36, S5-44, S5-48, S5-54, S5-58, S5-70, S5-74, S5-78, S5-82, S5-90, S5-94, and S5-100. As processing operations corresponding to the other processing operations shown in FIG. 5 have already been described above, the processing operations will not be described again here.

Many modifications can be made to the system described above within the scope of the accompanying claims.

For example, in the embodiment described above, each proxy server 6 is provided within intermediary server 2 at one location. However, instead, one or more of the proxy servers 6 may be located at a separate, remote location.

The processing at steps S2-40, S2-66, S5-40 and S5-86 in the system above is optional and may be omitted.

Similarly, the processing at steps S2-26, S2-28, S2-52, S2-54, S5-18, S5-20, S5-62 and S5-64 in the system described above is optional and may be omitted.

In the processing performed by content server data modifier 44 at steps S2-40, S2-66, S5-40 and S5-86, a link defining the content data stored within a different web server may be added instead of, or in addition to, a link to data stored at a location within database 48 at intermediary server 2.

In the processing performed by content server data modifier 44 at steps S2-40, S2-66, S5-40 and S5-86 in the system described above, each link is modified by adding a prefix thereto. However, a link may be modified in other ways, for example by changing part of the link, or by replacing the whole link with a different link.

In the system described previously, each content server data modifier 44 is provided as part of intermediary server 2. However, one or more of the content server data modifiers 44 may be provided as part of a content server 4 or as part of an apparatus interfacing with the content server 4. In this case, the content server data modifier 44 would be arranged to modify all links within data to be transmitted from the content server 4 to the intermediary server 2 so that each link defines a unique location. This may be achieved in the same way as described previously by adding a prefix to the link incorporating the domain name of the content server 4. Functionality may be retained within intermediary server 2 to perform the processing at steps S2-40, S2-66, S5-40 and S5-86, at which intermediary server content data is added to web page data received from a content server 4.

In the system described above, processing by the intermediary server is performed using processing routines defined by software programming instructions. However, some, or all, of the processing could be performed using hardware or firmware.

Other modifications are, of course, possible.

Applications

Some of the applications for which the system described above may be used will now be described.

In a first application, each content server 4 stores web site data for a vendor of products (that is, goods and/or services). The proprietor of intermediary server 2 provides access to the vendor content servers 4 through the intermediary server 2 in return for a fee from each vendor, thereby providing a web portal service with intermediary server 2 acting as a web portal. This fee may comprise a fixed fee (such as a one-off payment or a payment each month), a fee for each request that a user of a client apparatus 6 submits to a content server 4 requesting a vendor to contact him, and/or a fee which is a percentage of the value of each order for goods or services that a user of a client apparatus 6 places with a vendor's content server 4 via the intermediary server 2. The order may comprise a purchase of goods or servers, or a booking or reservation for a hotel, airline, theatre, restaurant, car rental, etc. Other types of order are also possible.

In this application, therefore, each client instruction analyser 42 within intermediary server 2 is arranged to perform processing at steps S2-26, S2-52, S5-18 and S5-62 to determine whether the client instructions define a contact form or an order from such as a purchase form, reservation form or booking form, etc. to be submitted to a content server 4. Consequently, each client instruction analyser 42 is arranged to perform processing at step S3-4 to determine whether the page is of a type “contact”, or “order” (that is “purchase”, “reservation”, “booking”, etc.).

The processing performed at steps S2-28, S2-54, S5-20 and S5-64 comprises storing a copy of the contact form or a copy of the order form (purchase, booking, reservation etc. form). Alternatively, to avoid storing credit card or bank details, in the case of an order, client instruction analyser 42 may be arranged to extract a subset of the data comprising data which uniquely identifies the order (such as the name under which the order was made, the date of the order, the goods or services ordered, the dates for which the booking/reservation was made, etc) and data defining the value of the order.

It should be noted that the processing performed at steps S2-26, S2-52, S5-18 and S5-62 to test data received from a client apparatus 6 to identify any orders or contact requests made by the client apparatus may be replaced with processing to test data received from a content server 4 to identify data sent by a content server 4 to confirm an order or booking request made by a client apparatus 6.

For this present application, intermediary server 2 may further comprise an invoice generating functional component which calculates an invoice for each vendor based upon the value of the orders placed through the intermediary server using the data stored at steps S2-28, S2-54, S5-20 and S5-64, and transmits the invoice to the content server 4 of the vendor (either electronically or by mail).

In a second application, intermediary server 2 may be used to implement security features by selectively controlling access by client apparatus 6 to the content servers 4. More particularly, client instruction analyser 42 may be arranged to perform processing at steps S2-26, S2-52, S5-18 and S5-62 to identify the web page requested by the client and to determine whether the client is allowed access thereto. Such a system therefore prevents the need to provide such an access controller for each content server 4. In this application, the processing to store a copy of the predetermined content at steps S2-28, S2-54, S5-20 and S5-64 would be replaced with processing to deny access if a request for a predetermined unallowable web page had been detected.

In a third application, intermediary server 2 may be configured to facilitate access to web pages stored at content servers 4 by disabled people, such as blind or partially sighted people.

In this application, instead of, or in addition to, adding a link to incorporate the logo of the intermediary server 2 in the processing at steps S2-40, S2-66, S5-40 and S5-86, each content server data modifier 44 within intermediary server 2 would be arranged to modify the data defining a web page received from content server 4 to incorporate additional information for use by a screen reader within the browser 18 of a client apparatus. By way of example, each content server data modifier 44 may be arranged to incorporate a description of a part of the web page (such as an image) to be read by the screen reader in the browser 18. By incorporating this functionality within the intermediary server 2, the requirement to modify each web page stored at a content server 4 is avoided.

In a fourth application, intermediary server 2 may be configured to detect and replace predetermined undesirable content within a web page from a content server 4 so that the undesirable content is not displayed at a client apparatus 6. More particularly, each content server data modifier 44 within intermediary server 2 may be arranged to perform additional processing at steps S2-38, S2-64, S5-38 and S5-84 so that not only is data from a content server 4 processed to identify and modify links, but also to identify any content which matches content stored in a database of undesirable content at intermediary server 2, and to modify the identified content for example by replacing or removing it.

By way of example, each content server data modifier 44 may be arranged to detect swear words in a web page and to replace these with stars. By way of a further example, each content server data modifier 44 may be arranged to detect non-English words and to replace the detected words with an English language translation. By way of yet a further example, each content server data modifier 44 may be arranged to identify out-of-date logos within a web page from a content server 4 and to replace each identified logo with a predetermined up-to-date logo. This may be particular useful for example when a group of companies, each having a different respective content server 4, is taken over by a new company. The new controlling company may then implement the system described above using intermediary server 2 to replace the logos of the previous company's with the logo of the new company, and to capture predetermined access to the content servers 4 (such as contact me requests or purchases as described above) to enable the new company to monitor centrally the performance of the web sites at the different content servers 4. By way of yet a further example, each content server data modifier 44 may be arranged to identify content that may not be compatible with the processing capability of the requesting client apparatus, and to remove or replace the requested content. For example intermediary server 2 may be arranged to identify that client apparatus 6 is a wireless device (such as a mobile telephone or personal digital assistant) and to modify the content of data received from content server 4 so that is compatible with the browser of the wireless client apparatus 6. Each content server data modifier 44 may also be arranged to remove content received from content server 4 if it is determined that the content cannot be transmitted to the client apparatus 6 such that it will be perceived to be received in real time by the user of client apparatus 6.

Many other applications are, of course, possible.

1. Apparatus for processing web page data, comprising:
a data receiver operable to receive web page data from a plurality of web servers;
a data modifier operable to process received data for each page to change links defined in the data to content to be displayed within the page, thereby generating modified web page data; and
a data transmitter operable to transmit the modified web page data to a client apparatus.

2. Apparatus according to claim 1, wherein the data modifier is operable to add a prefix to each link.

3. Apparatus according to claim 2, wherein the data modifier is operable to add a prefix based on the web address of the web server from which the data containing the link was received.

4. Apparatus according to claim 1, wherein the data modifier includes a data type selector operable to identify data of a predetermined type within which links are to be changed.

5. Apparatus according to claim 4, wherein the data type selector is operable to identify text data as data within which links are to be changed.

6. Apparatus according to claim 5, wherein the data type selector is operable to identify HTML text data as data within which links are to be changed.

7. Apparatus according to claim 1, wherein the data modifier includes a link selector operable to select links to be changed.

8. Apparatus according to claim 7, wherein the link selector is operable to identify and select absolute links as links to be changed.

9. Apparatus according to claim 1, wherein the data modifier is further operable to process data received from a web server to detect and modify predetermined content therein.

10. Apparatus according to claim 9, wherein the data modifier is operable to modify detected predetermined content by replacing a link to the content with a link to different content.

11. Apparatus according to claim 9, wherein the data modifier is operable to detect predetermined text data and to replace the detected predetermined text with different text data.

12. Apparatus according to claim 1, further comprising:
a request data receiver operable to receive request data from the client apparatus defining content required by the client apparatus for the display of a web page;
a link processor operable to process data received from the client apparatus to change links defined therein so as to remove changes to the links made by the data modifier, thereby returning the links to their unmodified form; and
a data transmitter operable to transmit data containing the links in their unmodified form to a web server.

13. Apparatus according to claim 1, further comprising a data adder operable to add data to web page data received from a web server defining content to be incorporated within the page.

14. Apparatus according to claim 13, wherein the data adder is arranged to add data comprising a link to content to be incorporated.

15. Apparatus according to claim 14, wherein the data adder is arranged to add data comprising a link to content stored at the apparatus.

16. Apparatus according to claim 13, wherein the data adder includes a data type selector operable to identify data of a predetermined type within which data is to be added.

17. Apparatus according to claim 16, wherein the data type selector is operable to identify HTML data as data within which data is to be added.

18. Apparatus according to claim 1, further comprising:
a data receiver operable to receive data from the client apparatus; and
a data type identifier operable to process data received from the client apparatus to determine whether the data is of a predetermined type.

19. Apparatus according to claim 18, wherein the data type identifier is operable to determine whether data received from the client apparatus is of a predetermined page type.

20. Apparatus according to claim 18, wherein the data type identifier is operable to determine whether data received from the client apparatus contains a request of a predetermined type.

21. Apparatus according to claim 20, wherein the data type identifier is operable to determine whether data received from the client apparatus contains a POST request.

22. Apparatus according to claim 18, further comprising a storage controller responsive to the identification of data of a predetermined type by the data type identifier to write at least some of the data to storage.

23. Apparatus according to claim 18, further comprising an access controller responsive to the identification of data of a predetermined type by the data type identifier to prevent access by the client apparatus to requested data defined in the data received from the client apparatus.

24. Apparatus according to claim 1, further comprising:
a decryptor operable to decrypt data received from a client apparatus;
an encryptor operable to encrypt data to be transmitted to a web server;
a decryptor operable to decrypt data received from a web server; and
an encryptor operable to encrypt data to be transmitted to a client apparatus.

25. Apparatus according to claim 1, further comprising a data compressor operable to compress the modified web page data for transmission to the client apparatus.

26. Apparatus for processing web page data, comprising:
a web page data processor operable to process web page data to change links defined in the data to content to be displayed within the web page, thereby generating modified web page data; and
a data transmitter operable to transmit the web page data to a web server for forwarding to a client apparatus.

27. A method of generating web page data, comprising:
receiving web page data from one of a plurality of web servers;
processing the received data for each page to change links defined in the data to content to be displayed within the page, thereby generating modified web page data; and
transmitting the modified web page data to a client apparatus.

28. A method according to claim 27, wherein processing is performed to change a link by adding a prefix thereto.

29. A method according to claim 28, wherein processing is performed to add a prefix based on the web address of the web server from which the data containing the link was received.

30. A method according to claim 27, wherein processing is performed to identify data of a predetermined type within which links are to be changed.

31. A method according to claim 30, wherein processing is performed to identify text data as data within which links are to be changed.

32. A method according to claim 31, wherein processing is performed to identify HTML text data as data within which links are to be changed.

33. A method according to claim 27, wherein processing is performed to select links to be changed.

34. A method according to claim 33, wherein processing is performed to identify and select absolute links as links to be changed.

35. A method according to claim 27, further comprising processing data received from a web server to detect and modify predetermined content therein.

36. A method according to claim 35, wherein processing is performed to modify detected predetermined content by replacing a link to the content with a link to different content.

37. A method according to claim 35, wherein processing is performed to detect predetermined text data and to replace the detected predetermined text with different text data.

38. A method according to claim 27, further comprising:
receiving request data from the client apparatus defining content required by the client apparatus for the display of a web page;
processing data received from the client apparatus to change links defined therein so as to remove changes to the links made previously, thereby returning the links to their unmodified form; and
transmitting data containing the links in their unmodified form to a web server.

39. A method according to claim 27, further comprising adding data to web page data received from a web server defining content to be incorporated within the page.

40. A method according to claim 39, wherein data comprising a link to content to be incorporated is added.

41. A method according to claim 40, wherein data comprising a link to content stored at the apparatus performing the method is added.

42. A method according to claim 39, wherein processing is performed to identify data of a predetermined type within which data is to be added.

43. A method according to claim 42, wherein processing is performed to identify HTML data as data within which data is to be added.

44. A method according to claim 27, further comprising:
receiving data from the client apparatus; and
processing data received from the client apparatus to determine whether the data is of a predetermined type.

45. A method according to claim 44, wherein processing is performed to determine whether data received from the client apparatus is of a predetermined page type.

46. A method according to claim 44, wherein processing is performed to determine whether data received from the client apparatus contains a request of a predetermined type.

47. A method according to claim 46, wherein processing is performed to determine whether data received from the client apparatus contains a POST request.

48. A method according to claim 44, wherein, in response to the identification of data of a predetermined type, further processing is performed to write at least some of the data to storage.

49. A method according to claim 44, wherein, in response to the identification of data of a predetermined type, further processing is performed to prevent access by the client apparatus to requested data defined in the data received from the client apparatus.

50. A method according to claims 27, further comprising:
decrypting data received from a client apparatus;
encrypting data to be transmitted to a web server;
decrypting data received from a web server; and
encrypting data to be transmitted to a client apparatus.

51. A method according to claim 27, further comprising compressing the modified web page data for transmission to the client apparatus.

52. A method of generating web page data, comprising:
processing web page data to change links defined in the data to content to be displayed within the web page, thereby generating modified web page data; and
transmitting the web page data to a web server for forwarding to a client apparatus.

53. Processing apparatus comprising a memory and a processor, the processor being operable to perform processing operations in accordance with computer-executable instructions stored in the memory, and the memory storing computer-executable instructions for causing the processor to perform a method of generating web page data, the method comprising:
processing web page data to change links defined in the data to content to be displayed within the web page, thereby generating modified web page data; and
transmitting the web page data to a web server for forwarding to a client apparatus.

54. A storage medium storing computer program instructions to program a programmable processing apparatus to become operable to perform a method of generating web page data, the method comprising:
processing web page data to change links defined in the data to content to be displayed within the web page, thereby generating modified web page data; and
transmitting the web page data to a web server for forwarding to a client apparatus.

55. A signal carrying computer program instructions to program a programmable processing apparatus to become operable to perform a method of generating web page data, the method comprising:
processing web page data to change links defined in the data to content to be displayed within the web page, thereby generating modified web page data; and
transmitting the web page data to a web server for forwarding to a client apparatus.

56. A method of providing a web server service, comprising:
providing an intermediary web server, through which a plurality of client apparatus can obtain access to web sites located at a plurality of vendor web servers;
monitoring data intended for receipt by the client apparatus that is transmitted from the vendor web servers through the intermediary web server, and modifying the data before transmitting it to the client apparatus;
monitoring data transmitted through the intermediary web server to identify orders placed by the client apparatus with the vendor web servers; and
charging each vendor a respective fee based upon the identified orders placed therewith.

57. A method according to claim 56, wherein data transmitted through the intermediary web server from the client apparatus to the vendor web servers is monitored to identify orders placed by the client apparatus with the vendor web servers.

58. A method according to claim 56, wherein data transmitted through the intermediary web server from the vendor web servers to the client apparatus is monitored to identify orders placed by the client apparatus with the vendor web servers.

59. A method according to claim 56, wherein the respective fee charged to each vendor comprises a percentage of a value of the orders placed therewith through the intermediary web server.

60. A method of providing a web server service, comprising:
providing an intermediary web server, through which a plurality of client apparatus can obtain access to web sites located at a plurality of vendor web servers;
monitoring data intended for receipt by the client apparatus that is transmitted from the vendor web servers through the intermediary web server, and modifying the data before transmitting it to the client apparatus;
monitoring data transmitted through the intermediary web server to identify contact requests placed by the client apparatus with the vendor web servers; and
charging each vendor a respective fee based upon the identified contact requests placed therewith.

61. A method of providing a web server service, comprising:
providing an intermediary web server, through which client apparatus can obtain access to web sites located at a plurality of vendor web servers;
monitoring data intended for receipt by the client apparatus that is transmitted from the vendor web servers through the intermediary web server, and modifying the data before transmitting it to the client apparatus; and
charging each vendor a fee.

62. A method of providing a web server service, comprising:
providing an intermediary web server, through which a plurality of client apparatus can obtain access to web sites located at a plurality of vendor web servers so as to retrieve and display web page data therefrom;
monitoring data transmitted through the intermediary web server; and
charging each vendor a respective fee based upon content of the monitored data.

63. A method of providing a web portal service, comprising:
providing a web portal that makes available a range of third party products that can be ordered from web sites of the third parties;
tracking usage of the web sites of the third parties using the web portal; and
charging for the usage.

64. Processing apparatus comprising a memory and a processor, the processor being operable to perform processing operations in accordance with computer-executable instructions stored in the memory, and the memory storing computer-executable instructions for causing the processor to perform a method of generating web page data, the method comprising:
receiving web page data from one of a plurality of web servers;
processing the received data for each page to change links defined in the data to content to be displayed within the page, thereby generating modified web page data; and
transmitting the modified web page data to a client apparatus.

65. A storage medium storing computer program instructions to program a programmable processing apparatus to become operable to perform a method of generating web page data, the method comprising:
receiving web page data from one of a plurality of web servers;
processing the received data for each page to change links defined in the data to content to be displayed within the page, thereby generating modified web page data; and
transmitting the modified web page data to a client apparatus.

66. A signal carrying computer program instructions to program a programmable processing apparatus to become operable to perform a method of generating web page data, the method comprising:
receiving web page data from one of a plurality of web servers;
processing the received data for each page to change links defined in the data to content to be displayed within the page, thereby generating modified web page data; and
transmitting the modified web page data to a client apparatus.
